(19) United States
(12) Patent Application Publication
(10) Pub. No.: US 2026/0043663 A1
(43) Pub. Date: Feb. 12, 2026

(54) IDENTIFYING EXPENSIVE SEGMENTS IN ROUTE PLANNING AND GUIDANCE

(71) Applicant: Uber Technologies, Inc., San Francisco, CA (US)

(72) Inventors: Yanran Chen, San Mateo, CA (US); Ilya Levin, San Francisco, CA (US); Aditya Arcot Srinivasan, Mountain View, CA (US); Kavya Sambana, Dublin, CA (US)

(21) Appl. No.: 18/798,497

(22) Filed: Aug. 8, 2024

(51) Int. Cl. G01C 21/34; G01C 21/36

(52) U.S. Cl. CPC G01C 21/3492; G01C 21/3461; G01C 21/3652

(57) ABSTRACT

Navigation routing is optimized to enhance guidance provided near potential route divergence points that increase route cost. Historical route data is used to determine costs for routes between an origin and destination. More expensive routes are compared to inexpensive routes to identify route segments found only in the expensive routes. The beginning of such a segment is labeled as an expensive divergence point for the route. When a routing request is received a routing engine determines the recommended route. A navigation engine identifies expensive divergence points located along the route and augments guidance related to the expensive divergence points—for example, by emphasizing maneuvers required to avoid deviating at the expensive divergence point. The augmented guidance may include audio, haptic, and visual cues that reduce the likelihood of deviating from the route, and highlight for the user the expensive nature of not staying on route at that point.

### BACKGROUND

Vehicle navigation systems are intended to route drivers to locations, typically by providing turn-by-turn directions. However, there are instances where following to the provided route may be impractical or impossible. These can range from unexpected road closures and construction work to sudden changes in traffic conditions, or simple human error such as a missed turn. Additionally, distractions inside the vehicle or environmental elements outside of it could also cause the driver to deviate from the suggested route.

When such deviations occur, the impact on the transportation process can reduce or even negate the initial optimization effort of the navigation system. While systems generally include a limited rerouting function, not all missed turns are of equal impact. Sometimes recovering is as simple as making the next turn instead, or making a U-turn. In other situations, such as on a controlled-access highway, a missed turn could add significant time to the route. Even on residential or non-limited access roads, costly delays can arise, and these are often in locations where the cost of a missed turn or other navigation instruction is not obvious to the driver. The result can be a significantly longer and more complicated route, leading to greater time and fuel consumption, increased wear and tear on the vehicle, and elevated levels of driver stress. These consequences pose challenges to both the driver's journey and the effective operation of traditional navigation systems.

### SUMMARY

Described embodiments include systems and methods for optimizing navigation to enhance guidance provided near potential route divergence points, and in particular route divergence points that significantly increase the cost of the deviation. For each origin and destination location pair, historical data is used by a data analysis pipeline module of the routing system to determine costs for a set of all routes between that origin and destination. The more expensive routes are then compared to one or more of the inexpensive routes to identify route segments that are only found in the expensive routes. Working backwards along the expensive route from such a segment, the data analysis pipeline identifies a route divergence point at the beginning of the segment—i.e. the most recent point shared by both the expensive route and any of the inexpensive routes. The data analysis pipeline labels such points as expensive divergence points for the route.

When a request is received by the routing system for a route from an origin to a destination, a routing engine determines the best recommended route. A navigation engine then identifies any expensive divergence points located along the route. As the navigation engine generates route guidance for the route, it augments guidance related to the expensive divergence points—for example, by emphasizing maneuvers required to avoid deviating from the route at the expensive divergence point. The augmented guidance in various embodiments includes audio, haptic, and visual cues that when presented to the user can reduce the likelihood of deviating from the route, and highlight for the user the expensive nature of not staying on route at that point.

These technical improvements to routing and guidance systems offer significant enhancements, as augmented navigation instructions ensure elevated alertness during critical points of the journey and reduce costly errors, while decreasing both congestion and pollution, and improving the efficiency of the overall road network.

### BRIEF DESCRIPTION OF THE DRAWINGS

FIG. 1 is a system architecture for identifying expensive segments in route planning and guidance, in accordance with some embodiments.

FIG. 2 is an example illustration of a historical intended route and an alternate route in accordance with some embodiments.

FIG. 3 is an example illustration of an identified expensive segment by the data analysis pipeline, in accordance with some embodiments.

FIGS. 4A and 4B are examples of interfaces with alerts for upcoming divergence points, in accordance with some embodiments.

FIG. 5 is a flowchart illustrating a method for providing route guidance in accordance with some embodiments.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

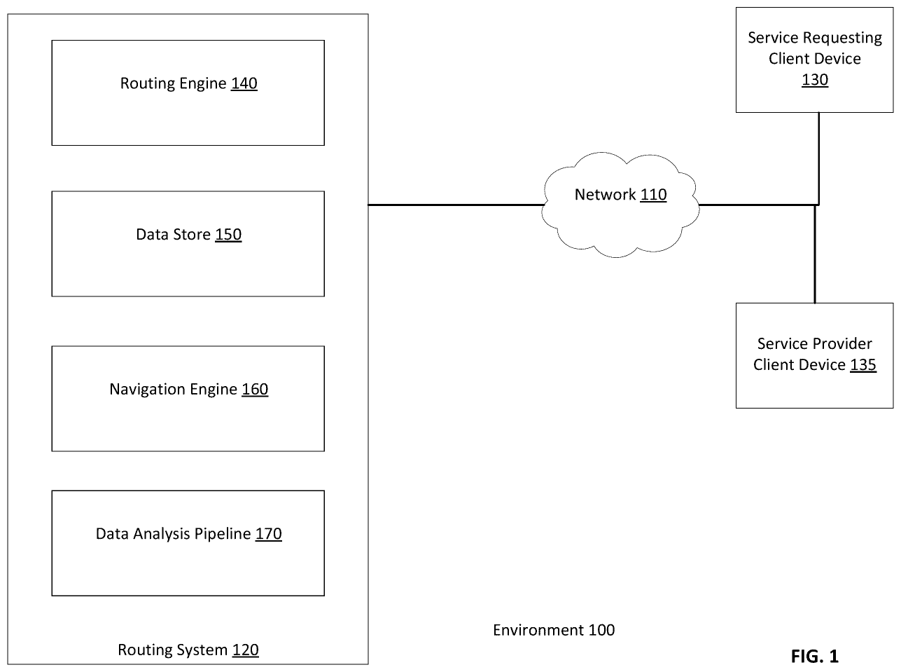

FIG. 1 shows an example environment including an example system architecture for providing optimized route guidance based on identified expensive segments, in accordance with some embodiments. The illustrated environment 100 includes a routing system 120 that communicates via network 110 with client devices such as a service requesting client device 130 and a service provider client device 135. In various embodiments, routing system 120 includes a routing engine 140, a data store 150, a navigation engine 160, and a data analysis pipeline 170. Each of these components is described below in further detail. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Service requesting client device 130 and service provider client device 135 (referred to collectively as client devices) are computing devices suitable for running operating systems and/or software applications that enable users (including autonomous vehicles) to request, obtain, and interact with navigation guidance instructions. The client devices can be desktop computers, laptop computers, smartphones, PDAs, tablets, or any other suitable device, and in some embodiments may be integrated directly into a vehicle.

Network 110 provides communication channels via which the other elements of the environment 100 communicate, including routing system 120, service requesting client device 130 and service provider client device 135. Network 110 can include any combination of local area and/or wide area networks, using both wired and/or wireless communication systems. In one embodiment, network 110 uses standard communications technologies and/or protocols. For example, network 110 can incorporate communication links using technologies such as Ethernet, Wi-Fi 6, 5G, 6G, Code Division Multiple Access (CDMA), Fiber-to-the-Home (FTTH), etc. Examples of networking protocols used for communicating via network 110 can include variants of Multiprotocol Label Switching (MPLS), Transmission Control Protocol/Internet Protocol (TCP/IP), Hypertext Transfer Protocol Secure (HTTPS), Simple Mail Transfer Protocol (SMTP), and Secure File Transfer Protocol (SFTP). Data exchanged over network 110 can be represented using any suitable format, such as Hypertext Markup Language (HTML5), JavaScript Object Notation (JSON), or extensible markup language (XML). In some embodiments, all or some of the communication links of network 110 may be encrypted using any suitable technique or techniques.

### Identifying Divergence Points and Expensive Segments

In general, and as recognized by those of skill in the art, each segment of a road network can have an associated cost, which is determined based on various factors alone or in combination, including travel time, distance, traffic conditions, road work, fuel efficiency, toll charges, fare charges, and the like. Cost information for a road segment, or for a group comprising multiple segments, may be determined in various embodiments by analyzing historical data. This data may have been obtained from vehicles or other devices that previously traversed the routes in question, as well as from additional sources such as public or private data providers. Cost information for road segments is stored, e.g., in data store 150, and is available to the modules of routing system 120 as needed for providing route guidance.

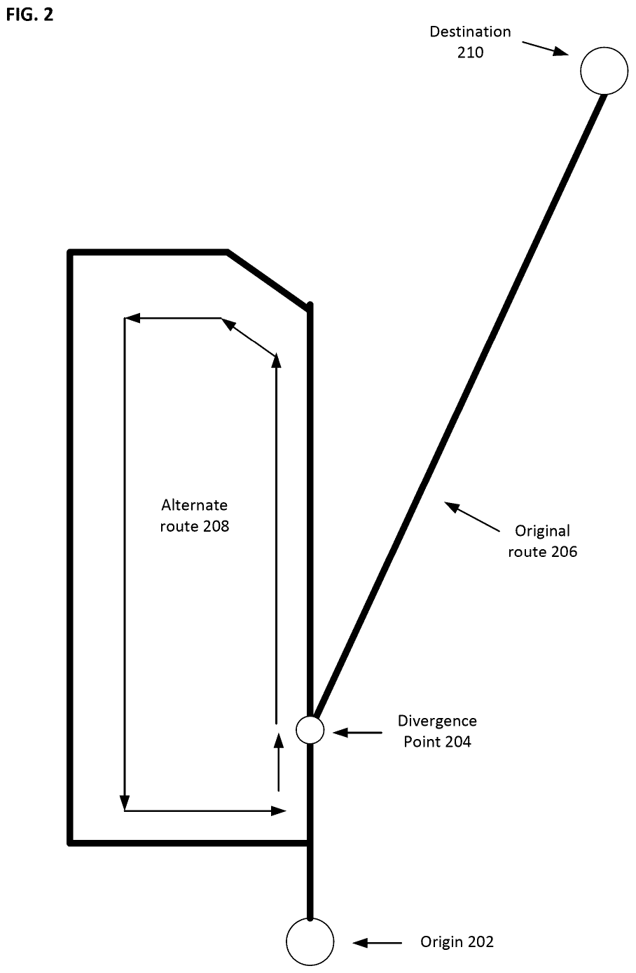

FIG. 2 illustrates an example of a historical intended route and alternate route that is used by data analysis pipeline 170 to determine expensive divergence points. For purposes of the remaining disclosure, we assume that the cost of a route is the aggregate cost of segments that form the route, though other implementations are possible at the discretion of the implementer. In FIG. 2, we also assume that guidance instructions were provided to a client device to assist in traversing the route from origin 202 to destination 210, and that the recommended route is route 206. When the vehicle reached divergence point 204, it ceased to follow the recommended route 206—as noted, there may be various explanations for why this occurred, including that the driver was not sufficiently aware of or prepared for the driving maneuver required to stay on the recommended route 206. Following the missed maneuver at the divergence point 204, an alternate route 208 was then followed in order to reach destination 210. In the illustrated example, the alternate route 208 used to recover from the missed maneuver adds time and complexity to the journey.

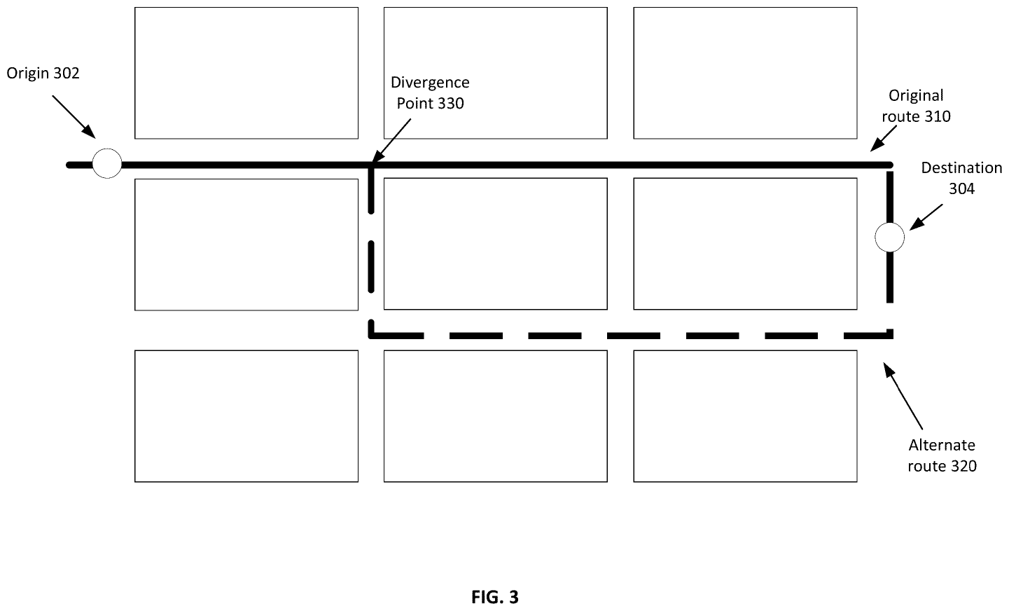

FIG. 3 illustrates a second example of a historical intended route and recovery route. In the example of FIG. 3, the route guidance provided from origin 302 to destination 304 was via original route 310. However, a divergence occurred at divergence point 330, and the vehicle actually traveled along alternate route 320.

For any combination of origins and destinations along the road network, there may be a plurality of routes for which historical information is available to data analysis pipeline 170.

Data analysis pipeline 170 thus considers, for a particular origin and destination, all of the routes for which historical information is available, and the cost of each of those routes. Note that while in the context of FIG. 2 and FIG. 3 above, the routes are described as original route and alternate or recovery route, data analysis pipeline 170 in various embodiments analyzes all routes traversed from the particular origin to the destination, regardless of whether a particular route was recommended.

Using the cost of each route in the set of routes from the particular origin to destination, data analysis pipeline 170 ranks the routes to identify which of the routes are the most expensive. A costly (expensive) route is any route having a cost that exceeds the cost of the optimal (lowest cost) route by a threshold amount, such as 20%. The threshold used to identify a route as expensive can vary depending on the factors that underly the cost function, for example such as time, distance, fare, and the like. In some embodiments, costs for a route are further segregated based on transient factors such as weather, time of day, construction, and the like. So, for example, the cost of different routes from an origin to destination may be different at night than during the day—the last exit before a bridge leaving the central business district at 4:00 PM on Friday may be an expensive divergence point, even though it is not an expensive divergence point at 3 AM on a Tuesday morning.

Next, data analysis pipeline 170 compares the segments traversed in each of the expensive routes to the segments traversed in the subset of less costly routes. For example, in one embodiment data analysis pipeline 170 begins with the segment leaving the origin in the expensive route being analyzed. If the segment is also present in the optimal route (or, in some embodiments, in any of the routes that are not labeled as expensive), then analysis pipeline 170 examines the next segment. When analysis pipeline 170 reaches a segment in the expensive route that is not present in the optimal route (or, in some embodiments, in any of the non-expensive routes), analysis pipeline 170 labels the point at which the divergence occurred as an expensive divergence point. For example, point 204 in FIG. 2 is labeled as an expensive divergence point if alternate route 208 is an expensive route, and the first segment of alternate route 208 is not also part of either the route or, in alternative embodiments, any other route not labeled as expensive.

Thus, for every expensive route from an origin to destination, data analysis pipeline 170 identifies an expensive divergence point. Pipeline 170 stores this information in data store 150 in association with the route.

In some embodiments, to reduce the computational expense of exhaustively comparing all routes between origin and destination, an alternative analysis is undertaken to identify expensive divergence points. As noted above, historical route data is accessible by data analysis pipeline 170. Route data includes, for each original route 206 that had a divergence, a divergence point 204 and alternate route 208 that was traversed instead of the original route.

Data analysis pipeline 170 then determines an incremental cost associated with the alternate route 208—that is, the extra cost incurred by virtue of deviating at divergence point 204 and taking alternate route 208.

Data analysis pipeline 170 then identifies the most expensive divergence points by determining which divergence points lead to the highest incremental cost alternate routes. For example, in one embodiment, the average incremental cost associated with each divergence point is calculated, and the divergence points with the highest average incremental cost, e.g., the costliest 20% of divergence points, are labeled as expensive. As above, the threshold for labeling a divergence point as expensive can be set by the implementer.

In some embodiments, data analysis pipeline 170 evaluates and stores how frequently a route from a given origin to a given destination includes an expensive divergence point—for example, in the illustration of FIG. 2, how frequently the turn at divergence point 204 is missed when traveling from the origin 202 to destination 210. As described below, navigation engine 160 in some embodiments uses this information to further refine the augmented guidance provided to a user.

### Route Requests

Routing system 120 receives a service request. For example, the routing system 120 receives a service request from a service requesting client device 130 or service provider client device 135. In various embodiments, a service request includes at least an origin location and a destination location. In some embodiments, the service request includes a time of service if the service is pre-scheduled. Routing engine 140, upon receiving the service request via network 110, generates a suggested route between the two points. Routing engine 140 determines the route between the origin location and the destination location along a set of road segments according to a map of the road segments in data store 150. Routing engine 140 calculates a suggested route between any two points and may consider a variety of factors such as distance, traffic conditions, time of day, weather conditions, mileage efficiency, tolls, fare cost, and known detours. In some embodiments, routing engine 140 also, in response to a request from service provider client device 135, suggests a route from a current location of the service provider to the origin location for the service. In some embodiments, the vehicle is an autonomous vehicle and the service provider client device 135 is networked with a guidance module that drives and directs the vehicle directly.

### Flagging Divergence Points

Routing engine 140 provides the determined route to navigation engine 160, which generates a set of guidance instructions for the suggested route. Guidance instructions are visual and/or audible instructions that are presented by a client device to a service provider and/or service requestor via a GUI or other interface to facilitate providing transport service along a suggested route. Guidance instructions include audio cues, textual cues, visual icons, and the like.

In generating the guidance instructions, navigation engine 160 retrieves from data store 150 the set of expensive divergence points associated with the route received from routing engine 140, taking into account any additional factors such as a planned time of the service request, weather conditions, or other parameters indicated in data store 150 as impacting the existence of expensive divergence points along the route. Using the retrieved information, navigation engine 160 generates guidance instructions that emphasize guidance maneuvers associated with the expensive divergence points. As noted, maneuvers include lane changes, speed changes, turns, exits from and entrances to controlled-access highways, and the like.

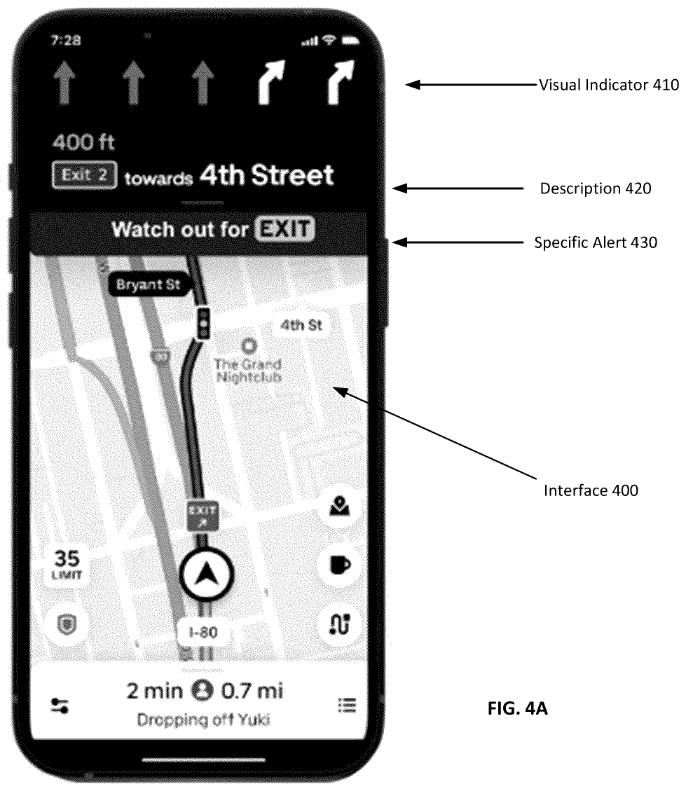

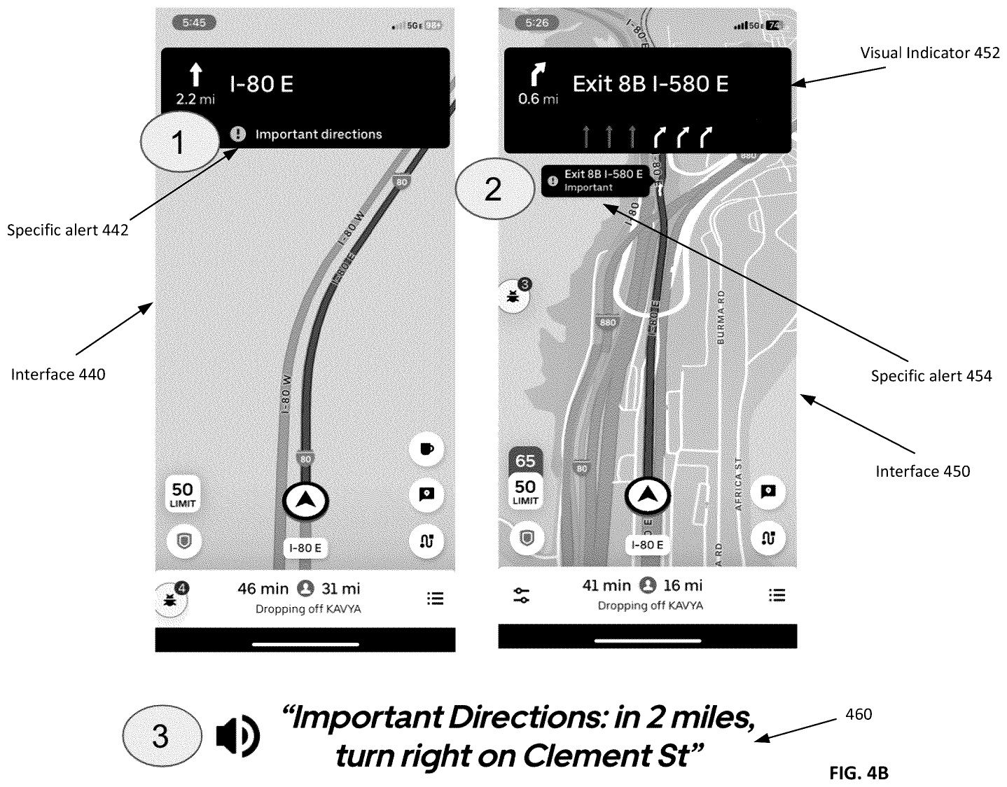

FIG. 4A is an example of an interface with alerts for upcoming expensive divergence points, in accordance with some embodiments. The example interface 400 in FIG. 4A demonstrates how the guidance for an upcoming turn may include multiple levels of detail and directions, including a visual indicator 410, a description 420, and a specific alert 430.

Alternative embodiments include more, fewer, or different interface features from those illustrated in FIG. 4A, and the functionality of each feature may be divided between the features differently from the description below.

In an example embodiment, responsive to determining that an upcoming portion of the route involves an expensive divergence point, the navigation engine 160 generates guidance instructions that use one or more features to provide an augmented level of guidance for maneuvers related to the upcoming divergence point. In various embodiments, augmented guidance features include a visual indicator 410, such as an indication of preferred lanes to use, a description 420 which describes the guidance in greater detail, and a specific alert 430 that highlights a specific element to look out for. Further feature options include vibrations, flashes of light, and/or auditory alerts set to occur at specific locations, milestones, distances and/or time markers. In some embodiments, the degree of augmentation is related to the degree of expense associated with the divergence point, which readily implies to the user the significance of deviating from the route at the point in question. For example in FIG. 4A, the specific alert 430 (“Watch out for EXIT”) may flash and be accompanied by an auditory alert to signify the importance of the maneuver. Guidance not associated with an expensive divergence point is presented in a standard, non-augmented fashion.

FIG. 4B shows two additional examples of interfaces with alerts for upcoming expensive divergence points, in accordance with some embodiments. In example interfaces 440, a specific alert 442 indicates that important directions are about to be displayed. This can serve as a pre-alert or pre-warning to a driver to help ensure that the important directions are observed when they are presented. Once the driver has progressed along the route and is closer to the potential divergence point, interface 450 is updated to include a relevant visual indicator 452 as well as the specific alert 454. In some embodiments, an audio cue is provided, and the text of the cue may be displayed contemporaneously, having an appearance 460 such as shown in FIG. 4B.

Because whether a divergence point is labeled as expensive is a determination based a particular route from an origin to a destination, those of skill in the art will recognize that the same guidance instructions can sometimes be provided by navigation engine 160 in an augmented fashion or in a normal fashion. For example, consider two different routes—a first route from origin A to destination X, and a second route from origin A to destination Y. Both routes begin with a vehicle traveling south on Broad Street, and both routes involve a right-hand turn at Bay Street. Based on the analysis previously done by data analysis pipeline 170, it turns out to be very expensive to miss the turn when traversing the first route to destination X, while at the same time it is of minimal consequence to miss the same turn when traveling to destination Y along the second route. Accordingly, in providing the first route to a first client device, navigation engine 160 augments the maneuver and turn instructions for the right turn at Bay Street, as described above, but does not provide augmentation for the same turn to a second client device traversing the second route.

As noted above, in some embodiments, a frequency is associated with each expensive divergence point, and navigation engine 160 uses this data to either further augment or deemphasize a specific alert associated with the divergence point. For example, and still referring to FIG. 4A, if Exit 2 is missed often—that is, a relatively high percentage of routes from origin to destination include the expensive divergence at Exist 2—then navigation engine 160 further augments the specific alert 430. Conversely, if an expensive divergence point is not frequently part of a route from origin to destination, navigation engine 160 reduces or eliminates the augmentation or specific alert for the related maneuver—for example, in a situation where turning instead of going straight has a high associated cost (i.e. it is an expensive divergence point), but almost all vehicles do in fact go straight at that point, it is not necessary to emphasize the maneuver for the user, and in fact doing so may reduce the effectiveness of augmented guidance in other situations.

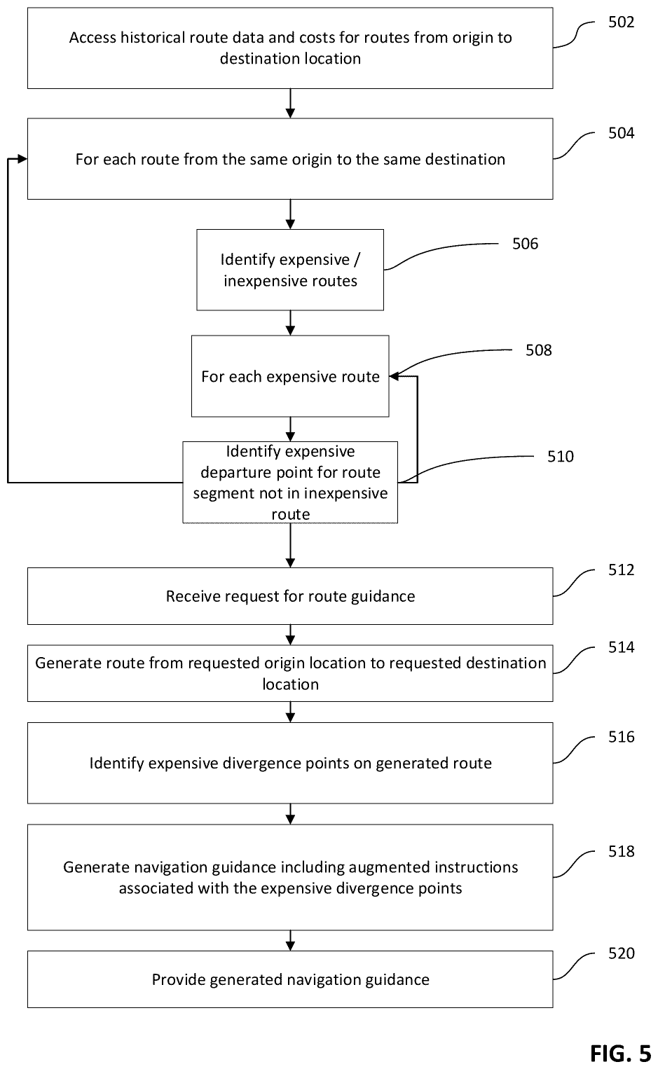

FIG. 5 illustrates a method for providing navigation guidance in accordance with one embodiment. Data analysis pipeline 170 accesses 502 historical route data and costs for routes from origin to destination locations. Then, for 504 each route from the same origin to the same destination, data analysis pipeline 170 identifies 506 expensive and inexpensive routes as described above. For 508 each of the expensive routes, data analysis pipeline 170 identifies 510 and labels departure points that lead to one or more segments not on an inexpensive route.

When routing system 120 receives 512 a request for routing guidance, e.g., from a service requesting client device 130 or service provider client device 135, routing engine 140 generates 514 a route between the origin and destination locations received in the request and provides the route to navigation engine 160. Navigation engine 160 examines the received route to identify 516 expensive divergence point that are located along the route and generates 518 guidance instructions for traversing the route. In generating the instructions, as described above, navigation engine 160 emphasizes maneuvers that are associated with upcoming expensive route departure points along the route, such as by providing earlier warnings of the maneuver; using differentiated fonts, colors, and/or image size; audio, visual, and/or haptic cues; and the like, to reduce the likelihood of a missed maneuver and a subsequent route departure.

Once navigation engine 160 has generated the guidance instructions including augmented guidance to avoid expensive departure points, routing system 120 responds to the guidance request by providing 520 the recommended route and accompanying guidance instructions to the requester, which then displays the received route and guidance information to a user of the requesting device.

### Miscellaneous

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

We claim:

1. A method for optimizing route guidance for a vehicle, the method comprising:
accessing historical route data in a data store, the historical route data associated with a plurality of routes traveled by vehicles, each route having an origin location, a destination location, and a cost;
for a set of routes, each route in the set having a same origin location and a same destination location:
identifying a subset of inexpensive routes, each route in the subset of inexpensive routes having a cost exceeding a lowest cost for the route by less than a threshold amount;
for each route not in the subset of inexpensive routes:
identifying a route segment along the route from the origin location to the destination location that is not in any of the routes in the subset of inexpensive routes;
labeling a point at which the identified segment begins as an expensive divergence point; and
storing an indication in the data store that associates the expensive divergence point with the origin location and destination location pair;
receiving a service request including a first origin location and a first destination location;
generating a route from the first origin location to the first destination location;
identifying at least one expensive divergence point associated with the first origin location and first destination location pair and located on the generated route;
generating navigation guidance according to the generated route and identified expensive divergence points, the navigation guidance including non-augmented instructions and augmented instructions, the augmented instructions associated with the expensive divergence points; and
providing the generated navigation guidance to the requestor in response to the request.

2. The method of claim 1, wherein the received service request includes a time of service and the at least one expensive divergence point is identified based on the time of service.

3. The method of claim 1, wherein the threshold amount is a percentage.

4. The method of claim 1, wherein the augmented instructions include a haptic alert and the non-augmented instructions do not include the haptic alert.

5. The method of claim 1, wherein the augmented instructions include a visual alert and the non-augmented instructions do not include the visual alert.

6. The method of claim 1, wherein at least one of the expensive divergence points is a turn.

7. The method of claim 1, wherein at least one of the expensive divergence points is an exit from a controlled-access highway.

8. A routing system for providing augmented route guidance for a vehicle, the system comprising:
a data analysis pipeline module, executed by a processor and adapted to:
access historical route data in a data store, the historical route data associated with a plurality of routes traveled by vehicles, each route having an origin location, a destination location, and a cost;
for a set of routes, each route in the set having a same origin location and a same destination location:
identify a threshold route cost;
identify a subset of inexpensive routes, each route in the subset of inexpensive routes having a cost exceeding a lowest cost for the route by less than a threshold amount;
for each route not in the subset of inexpensive routes:
identify a route segment along the route from the origin location to the destination location that is not in any of the routes in the subset of inexpensive routes;
label a point at which the identified segment begins as an expensive divergence point; and
store an indication in the data store that associates the expensive divergence point with the origin location and destination location pair;
a routing engine, executed by the processor, adapted to:
receive a service request including a first origin location and a first destination location; and
generate a route from the first origin location to the first destination location;
a navigation engine, executed by the processor, adapted to:
identify at least one expensive divergence point associated with the first origin location and first destination location pair and located on the generated route;
generate navigation guidance according to the generated route and identified expensive divergence points, the navigation guidance including non-augmented instructions and augmented instructions, the augmented instructions associated with the expensive divergence points; and
provide the generated navigation guidance to the requestor in response to the request.

9. The system of claim 8, wherein the received service request includes a time of service and the at least one expensive divergence point is identified based on the time of service.

10. The routing system of claim 8, wherein the threshold amount is a percentage.

11. The routing system of claim 8, wherein the augmented instructions include a haptic alert and the non-augmented instructions do not include the haptic alert.

12. The routing system of claim 8, wherein the augmented instructions include a visual alert and the non-augmented instructions do not include the visual alert.

13. The routing system of claim 8, wherein at least one of the expensive divergence points is a turn.

14. The routing system of claim 8, wherein at least one of the expensive divergence points is an exit from a controlled-access highway.

15. A computer program product for optimizing route guidance for a vehicle, the computer program product stored on a non-transitory computer-readable medium and including instructions to cause a processor to execute steps comprising:
accessing historical route data in a data store, the historical route data associated with a plurality of routes traveled by vehicles, each route having an origin location, a destination location, and a cost;
for a set of routes, each route in the set having a same origin location and a same destination location:
identifying a threshold route cost;
identifying a subset of inexpensive routes, each route in the subset of inexpensive routes having a cost exceeding a lowest cost for the route by less than a threshold amount;
for each route not in the subset of inexpensive routes:
identifying a route segment along the route from the origin location to the destination location that is not in any of the routes in the subset of inexpensive routes;
labeling a point at which the identified segment begins as an expensive divergence point; and
storing an indication in the data store that associates the expensive divergence point with the origin location and destination location pair;
receiving a service request including a first origin location and a first destination location;
generating a route from the first origin location to the first destination location;
identifying at least one expensive divergence point associated with the first origin location and first destination location pair and located on the generated route;
generating navigation guidance according to the generated route and identified expensive divergence points, the navigation guidance including non-augmented instructions and augmented instructions, the augmented instructions associated with the expensive divergence points; and
providing the generated navigation guidance to the requestor in response to the request.

16. The computer program product of claim 15, wherein the received service request includes a time of service and the at least one expensive divergence point is identified based on the time of service.

17. The computer program product of claim 15, wherein the at least one expensive divergence point is identified based on weather conditions.

18. The computer program product of claim 15, wherein the threshold amount is a percentage.
